(19) United States
(12) Patent Application Publication
(10) Pub. No.: US 2012/0037074 A1
(43) Pub. Date: Feb. 16, 2012

(54) Automated Thermal Spray Apparatus

(76) Inventor: Mike Outland, Waterloo, IL (US)

(21) Appl. No.: 12/912,314

(22) Filed: Oct. 26, 2010

Related U.S. Application Data
(60) Provisional application No. 61/372,357, filed on Aug. 10, 2010.

(51) Int. Cl. B05C 11/00; B05C 5/00

(52) U.S. Cl. 118/696; 118/323

(57) ABSTRACT

An automated thermal spraying apparatus for the automated and uniform application of a thermal spray to the surface of a substrate through regulation of vertical and horizontal components of motion and the rate of the thermal spray.

### CROSS REFERENCE TO RELATED APPLICATION(S)

This application claims the benefit of U.S. Provisional Patent Application Ser. No. 61/372,357, filed Aug. 10, 2010, the entire disclosure of which is herein incorporated by reference.

### BACKGROUND OF THE INVENTION

1. Field of the Invention

This disclosure is related to the field of automated apparatuses for the application of thermal spray coatings.

2. Description of Related Art

Generally, coatings can be thought of as engineering solutions to enhance surfaces against wear, corrosion, thermal degradation and other surface phenomena. Acceptable coatings are generally characterized by good adhesion, substrate compatibility and low porosity. In addition to holding these characteristics, the process by which the coating is applied must be compatible with physical substrate constraints such as temperature and geometry. These coating/substrate attributes include coefficient of thermal expansion (“CTE”) matching, appropriate edge radii, substrate melting point and chemical compatibility during deposition and service.

Thermal spray coatings are some of the coatings that can be tailored to meet many of the aforementioned requirements. Thermal spray coatings are a versatile and well-established means of protecting metals from corrosion in a wide variety of environments. In their most basic form, thermal spray coatings can be defined as a coating produced by a process in which molten or softened particles are applied by impact onto a substrate.

Flame spray, the first thermal spray process, was invented nearly one hundred (100) years ago. Early applications of thermal spray were for simple shaft repair and roll restoration and surfacing. Relatively simple metals and alloys were employed for each of these applications. During the mid-1950s, thermal spray usage and applications advanced significantly with the introduction of plasma arc spray and detonation spray. Since that time, thermal spray coatings have been widely commercialized, finding their way into most industries.

Thermal sprays have grown from the simple iron and steel coatings used in earlier applications. Today, many different materials can be used to produce thermal sprayed coatings, thereby providing effective solutions to diverse corrosion problems. These materials—including metals, ceramics, polymers and combinations thereof—may be used to impart improved wear, abrasion resistance and reliable long-term corrosion protection to substrates. Thermal spray coatings can be found in applications ranging from oil fields to aerospace. Specific applications include surgical instruments, medical implant prosthetics, medical diagnostics, turbine engine components, papermaking machines, printing rolls, petrochemical pumping and valving, communications, electronics, cookware and countless others.

Historically, the art of applying thermal spray coatings was practiced in specialty service and job shops. While advances in thermal spray processes and materials—coupled with advances in process control, instrumentation and automation—have taken thermal spray into high-volume production applications, it is still a largely manually controlled process of application. Thus, in the end, the quality of the thermal spray coating application is determined by the skill and education of the practitioner who is applying the spray.

Thermal spray processes differ from other coating processes because they are nonatomistic. In other words, they do not deposit material onto surfaces as individual atoms, ions or molecules. Instead, relatively massive particulates are deposited onto the surface in the form of liquid droplets or semimolten solid particles.

In the thermal spraying process, the coating materials to be deposited (known as the feedstock) typically come in the form of powder, wires, rods, liquid or a suspension. The particular feedstock utilized depends upon the particular thermal spraying process that is employed. The materials are usually heated to their melting point by a plasma jet, electric arc or flame. The temperatures of these materials during application can range from 4,500 F to 30,000 F. After heating, the molten material is atomized into micrometer-size particles and propelled toward the substrate by process gases or atomizing jets formed through nozzles. Once contact with the substrate is achieved, the molten droplets flatten, rapidly solidify and then form a deposit. The deposits consist of a multitude of pancake-like lamellae also known as “splats” which are formed by the flattening of the liquid droplets that occurs when they hit the substrate at high velocities. The resulting coatings are made by accumulation of numerous sprayed particles layered upon each other. As the sprayed feedstock particles range in size from a few micrometers to above 100 micrometers, the resultant lamellae have thicknesses in the micrometer range and lateral dimensions from several to hundreds of micrometers. Between the lamellae in the final thermal coating are small voids, such as pores, cracks and regions of incomplete bonding.

As a result of this unique structure of the end product, thermal coating has properties that are significantly different from the feedstock bulk raw materials. These properties include lower strength and modulus, higher strain tolerance and lower thermal and electrical conductivity. Thus, the final end product thermal coating consists of overlapping layers of “splats” interlockingly dispersed amongst each other on the surface of the substrate, thereby creating a dense, tightly bound coating.

Notably, thermal spray application processes are “line-of-sight” processes, meaning that the projected stream of droplets deposits only onto surfaces that are directly in line with the spray stream. In addition to being “line-of-sight” processes, thermal spray coatings are considered to be “overlay” coatings. “Overlay” coatings are materials added to an original surface (known as the substrate) where there is little or no mixing or dilution between the coating and the substrate, thus preserving the composition of the base material.

Over the history of thermal spraying, several different variations of thermal spraying have been developed. In fact, thermal spray can be used as a generic term to describe a group of processes, including flame spraying, plasma spraying, arc metallization, detonation gun, high-velocity oxyfuel and cold spray, that can be used to apply a variety of different coating materials for corrosion protection. Although these processes encompass a wide range of equipment needs, costs, materials selection and application, they can all be treated as belonging to the same family since the processing variables that are being altered are the temperature and the particle velocity. In all of the different types of thermal spraying processes, a feedstock is rapidly heated and then accelerated toward a suitably prepared substrate where on impact it consolidates to form an adherent coating.

Generally, a thermal spray system consists of the following: a spray torch, a feeder, media supply, a power supply and a control console. The spray torch (or spray gun) is the core device in the system which performs the melting and acceleration of the particles to be deposited. The feeder is for supplying the powder, wire or liquid to the torch. The media supply is the gases or liquids used for the generation of the flame or plasma jet and the gases or liquids for carrying the powder.

No matter the type of process chosen, there are several different variables in thermal spray processes that work to produce a “good” or a “bad” quality coating; i.e., they influence the interaction of the particles with the substrate and, therefore, the deposit properties. Coatings applied by the same technique can exhibit a wide variety of variability that arises from the manipulation of processing variables such as gas flow rates, the rate of coating deposition, the coating thickness, substrate preparation (e.g., preheat, postheat and surface preparation schedules), type of spray material used and the torch-to-substrate distance. These thermal spray parameters influence the quality of the adhesion to the substrate and the material properties such as electrical conductivity, density and porosity. For these reasons, it is incorrect to assume that all thermally sprayed coatings of a particular material are identical in performance.

In the prior art, the variables inherent in thermal spray processes where optimized to create an acceptable end-product coating by the manipulation of the spray gun by an experienced thermal spray engineer. The thermal spray engineer had to have the ability to set-up, operate and secure the thermal spray equipment in such a way as to impart a uniform coating onto the substrate. This requires years of training in the complex art of the application of thermal sprays. In addition to limiting the number of qualified individuals able to properly operate thermal spray equipment, this dramatically increases the costs associated with the thermal spray process (e.g., the cost to train thermal spray engineers and the cost to employ competently trained and skilled thermal spray engineers). Further, no matter the skill level of the thermal spray engineer, manual operation of the thermal sprayer always carries with it an inherent degree of human error in application. As noted previously, thermal spray coatings are made by accumulation of numerous sprayed particles layered upon each other. The final end product thermal coating consists of overlapping layers of “splats” interlockingly dispersed amongst each other on the surface of the substrate, thereby creating a dense, tightly bound coating. Inaccurate application of the spray onto the substrate by a thermal spray technician by the failure to maintain constant one or more of the many parameters inherent in thermal spray coatings can compromise the quality of the end product coating. For example, the failure of a trained thermal spray technician to keep a constant distance from the substrate throughout the spraying process or the failure to apply the spray passes in such a way that they consistently overlap the previous passes, results in poor quality, and uneven coatings with variable thicknesses.

In addition to the high skill level needed by a technician and the probability of human error in application, manual application of thermal spray coatings also encounters problems due to the inherent risks and hazards involved in the thermal spray coating process. As with any industrial process, there are a number of hazards in the thermal spray process. Noise pollution is created by the metal spraying equipment which uses compressed gases. While sound levels vary with the type of spraying equipment, the materials being sprayed and the operating parameters, in most instances it is a significant consideration for the operator of the spray gun. In addition to noise, the spraying equipment utilized can produce an intense flame (which may have a peak temperature of more than 3,100° C. and can be very bright) or ultra-violet light which may damage the operator's delicate body tissues. Lastly, the atomization of molten materials in the thermal spray process works to produce a certain amount of dust and fumes. Thus, proper extraction equipment is vital for an operator, not only for personal safety, but to minimize the entrapment of re-frozen particles in the sprayed coatings. Depending on the type of feedstock utilized, the dust and fumes inherent in the thermal spray process may react with water to create the potential for explosions.

While some robotics and automated applications have been utilized to replace the thermal spray engineer in the manual application of thermal spray coatings, these robots and automated applications are generally complex and expensive technologies that greatly add to the expense of the thermal spray coating procedure. Thus, while they address the consistency problems inherent in the manual application of thermal sprays, the increased production costs associated with the utilization of these robotics are prohibitive to their widespread use and application.

Taking these variables together, what is needed in the art of thermal spray coating technology is an inexpensive reliable automated process for the uniform application of a thermal spray to a given substrate.

### SUMMARY OF THE INVENTION

Because of these and other problems in the art, described herein is an automated thermal spray apparatus. The automated thermal spray apparatus described herein is comprised of: a vertical support, a platform attached to the vertical support, a control box, the control box including a motor for moving the platform of the automated thermal spray apparatus up and down the vertical support, a secondary motor, a mechanical arm attached to the platform and to the secondary motor, a rail attached to the platform; a sliding mechanism attached to the mechanical arm and moveably attached to the rail; wherein the motor of the control box moves the platform up and down the vertical support to create a vertical component of motion; wherein the secondary motor imparts motion on the mechanical arm and the mechanical arm imparts motion on the sliding mechanism to move the sliding mechanism along the rail to create a horizontal component of motion.

In one embodiment of the automated thermal spray apparatus, the vertical support is comprised of a single bar. In another embodiment, the vertical support is a minor image of a substrate being sprayed by the automated thermal spray apparatus.

In yet another embodiment, the vertical support is comprised of one or more bars located in the same vertical plane. It is also possible in some embodiments that the end of the vertical support oriented towards the ground is attached to a base.

In some embodiments of the thermal spray apparatus the base is motive.

In another embodiment of the thermal spray apparatus, the motor for moving the platform up and down the vertical support of the automated thermal spray apparatus is a stepper motor.

It is further contemplated that in some embodiments of the thermal spray apparatus, the control box further comprises a processor for automating the vertical component of movement of the platform. Computer-aided technologies, programmable logic controllers, artificial neural networks, distributed control system, human machine interface, programmable automation controllers, instrumentation, motion control, robotics and an on/off switch are all possible contemplated processors for automating the vertical component of movement of the platform.

In some embodiments of the automated thermal spray apparatus, the control box regulates the rate and frequency of said horizontal component of motion. In other embodiments, the control box can also regulate the rate of said spray disbursed from said spray gun.

In one embodiment of the automated thermal spray apparatus, the mechanical arm comprises: a secondary flange having a distal and a proximal end and a length therebetween and a main arm having a distal and a proximal end and a length therebetween; wherein the distal end of the secondary flange is attached to the secondary motor, the proximal end of the secondary flange is attached to the main arm at the length therebetween the distal and the proximal ends of the main arm, the distal terminal end of the mechanical arm is rotably attached to the platform, and the secondary motor imparts motion to the secondary flange, the secondary flange imparts motion to the main arm and the main arm imparts motion to the sliding mechanism to move the sliding mechanism along a length of the rail to create a horizontal component of motion.

In some embodiments of the automated thermal spray apparatus, the sliding mechanism will be moveably attached to the rail by slider rollers. The rail of the automated thermal spray apparatus can be a linear rail in some embodiments and a curved rail in other embodiments. Further, in some embodiments the rail is comprised of a single track, whereas in other embodiments the rail is comprised of one or more tracks with a space therebetween.

A thermal spray gun is attached to the sliding mechanism in some embodiments of the automated thermal spray apparatus.

In yet other embodiments of the thermal spray apparatus, the vertical component of motion and the horizontal component of motion work in tandem to create a final thermal spray covering of uniform thickness on a surface area of a substrate of a uniform composition. For example, in one embodiment the automated thermal spray apparatus is regulated to create a one-third overlay of thermal spray on a substrate from one horizontal pass of the sliding mechanism to a subsequent pass of the sliding mechanism.

### BRIEF DESCRIPTION OF THE DRAWINGS

FIG. 1 provides a perspective view of the automated thermal spray apparatus from a side perspective.

FIG. 2 provides a perspective view of the automated thermal spray apparatus from a rear side perspective.

FIG. 3 provides a perspective view of the horizontal rail and thermal spray sliding mechanism of the automated thermal spray apparatus.

FIG. 4 provides a perspective view from the vertical track side of the automated thermal spray apparatus.

FIG. 5 provides a view of the horizontal rail along which the thermal spray sliding mechanism moves in a fixed path and the mechanical arm which imparts movement to the thermal spray sliding mechanism.

### DESCRIPTION OF THE PREFERRED EMBODIMENT(S)

The present disclosure describes an automated thermal spray apparatus (101) for the application of thermal sprays to a given substrate. Generally, the apparatus (101) disclosed herein consists of a number of component parts. In this disclosure, the component parts of the automated thermal spray apparatus will first be discussed separately. Then the component parts will be discussed together as a functioning automated thermal spray apparatus (101).

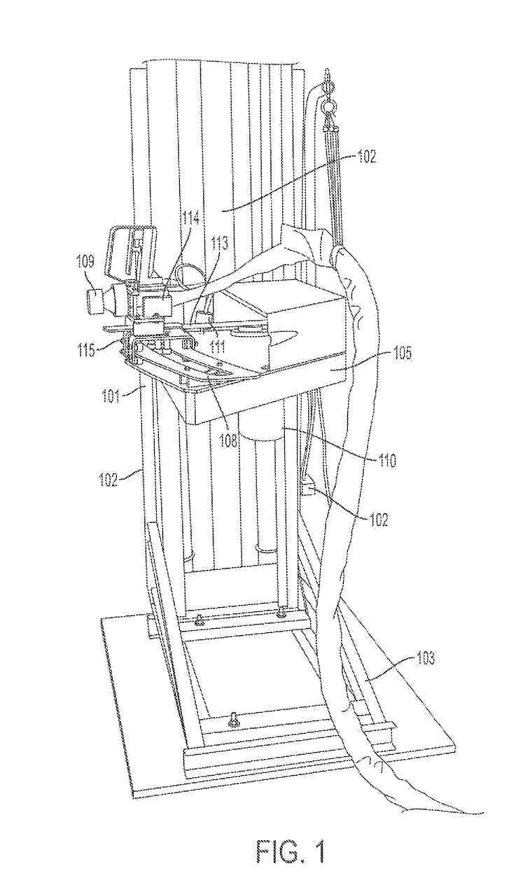

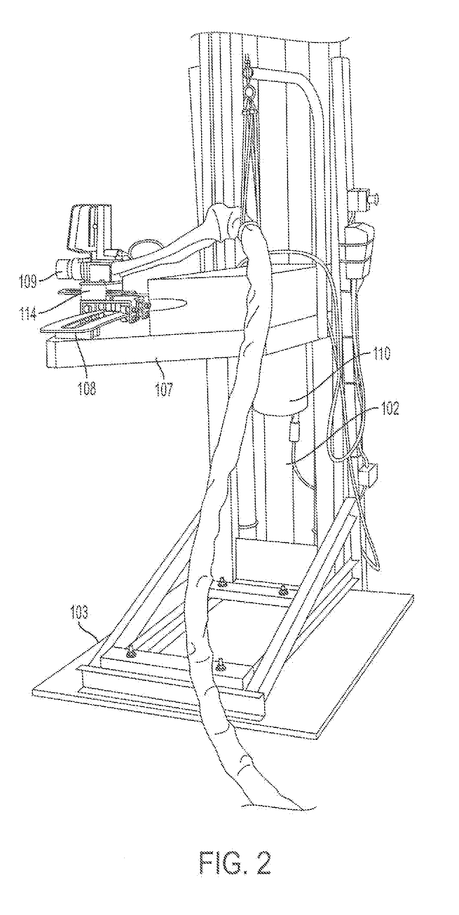

One component part of the thermal spray apparatus (101) which will be discussed is the vertical support (102). The vertical support (102) of the thermal spray apparatus (101) can be viewed in FIGS. 1, 2 and 4. As depicted in the FIGs., the vertical support (102) is the spine of the automated thermal spray apparatus (101). The vertical support (102) is generally oriented in an upright position perpendicular to the plane of the horizon and generally parallel to the surface area of the substrate upon which the thermal spray will be applied. In its most basic form, the vertical support (102) consists of a single bar of metal, wood, plastic or other component suitable for supporting vertical movement of the platform (107) of the automated thermal spray apparatus (101). The vertical support (102) can consist of one or more bars of metal, wood, plastic or other components suitable for supporting the platform (107) of the automated thermal spray apparatus (101) in movement up and down a vertical axis. In the embodiments of the automated thermal spray apparatus (101) with a vertical support (102) of more than one bar, the multiple bars can be attached to each other to create a singular multi-bar vertical support (102). One example of this type of singular multi-bar vertical support (102) is depicted in FIGS. 1, 2 and 4. In alternative embodiments of the multi-bar vertical support (102), the multiple bars that comprise the vertical support (102) are not attached to each other, but are located in the same general vertical plane.

Taken together, a person of ordinary skill in the art would recognize that any vertical bar that is capable of supporting the movement of the platform (107) of the automated thermal spray apparatus (101) on the vertical axis it defines is contemplated as a possible vertical support (102) of the automated thermal spray apparatus (101).

In some embodiments of the vertical support (102), the ends of the support or supports oriented towards the earth are attached to a base (103). It is contemplated that the base (103) may be any type of metal, wood, concrete or other solid structure to which the vertical support (102) can be attached to impart stability to the vertical support (102). For example, as depicted in FIGS. 1, 2 and 4, the base (103) consists of a horizontal metal framework attached to a piece of metal sheeting fixed upon a wooden pallet. The wooden pallet provides the apparatus (101) with the capability to be generally transportable by forklift or other fork-associated apparatus. This is just one example of the multiple forms the base (103) of the automated thermal spray apparatus (101) could take. Again, a person of ordinary skill in the art would recognize that any shape base (103) that could support the vertical support (102) of the automated thermal spraying apparatus (101) is contemplated in the term “base” as utilized in this application. Further, a person of ordinary skill in the art would recognize that the attachment of the vertical support (102) to the base (103) can be accomplished by one or more points of attachment.

In alternative embodiments, the base (103) will be motive. In these certain embodiments, the base (103) will be attached to a track, belt, rollers, wheels, or other means known to those of skill in the art whereby the entire automated thermal spray apparatus (101) can be moved to another place or position relative to a certain surface area of the substrate. In these motive embodiments, it is contemplated that the base (103) would have some type of brake means by which the automated thermal spray apparatus (101) can be locked or secured in a fixed position in front of a given portion of the surface area of the substrate in the spraying process.

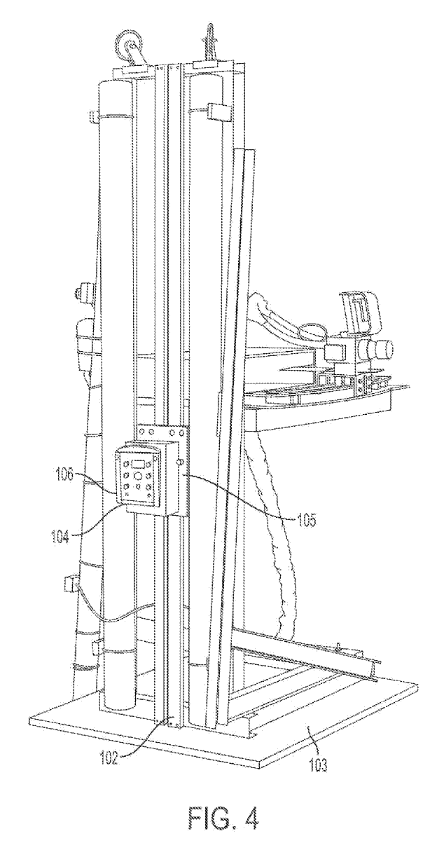

Another component part of the thermal spray apparatus (101) is the control box (104). The control box (104) of the thermal spray apparatus can be viewed in FIG. 4. In some embodiments of the thermal spray apparatus (101), the control box (104) can be attached to the vertical support (102). This arrangement is depicted in FIG. 4. However, it should be noted that any attachment of the control box (104) to the thermal spray apparatus (101) which allows for the motor (105) of the control box (104) to impart vertical motion to the platform (107) up and down the vertical support (102) is contemplated in this application.

The control box (104) is comprised of a motor (105) for imparting vertical motion to the platform (107) of the automated spraying apparatus (101). Stated differently, the control box (104) contains a system or means (105) for moving the platform (107) of the automated spraying apparatus (101) up and down the vertical support (102) of the automated spraying apparatus (101). In one embodiment, it is contemplated that this motor (105) for moving the platform (107) of the automated spraying apparatus (101) in a vertical motion up and down the vertical support (102) of the automated spraying apparatus (101) is an electric motor that uses electric energy to produce mechanical energy. In another embodiment of the automated thermal spray apparatus (101), this motor (105) is a stepper motor such as, but not limited to, a Bug-O® carriage motor. One of ordinary skill in the art would recognize that any type of motor or other means (105) for imparting mechanical energy and motion to the platform (107) of the automated spraying apparatus (101) to steadily climb up and down the vertical axis of the vertical support (102) is a contemplated as a means (105) for moving the platform (107) up and down the vertical axis of the vertical support (102).

In some embodiments of the automated thermal spray apparatus (101), the control box (104) may also contain a means (106) for automating the rate or progression of the vertical movement of the platform (107) up and down the vertical support (102). However, it should be noted that this automotive means (106) is not necessary, as the motor (105) can simply be activated via an on/off switch. In alternative embodiments, the control box (104) may also contain a system or means for automating the rate of thermal spray dissipating from the thermal spray gun (109) which is attached to the sliding mechanism (114) and/or a system or means for automating the movement of the sliding mechanism (114) along the rail (108). Any means for automating the mechanical movement of an apparatus known to those of skill in the art is contemplated in this application as these various automotive means. These include, but are not limited to, computer-aided technologies (CAx), programmable logic controllers (PLC), an artificial neural network (ANN), a distributed control system (DCS), a human machine interface (HMI), a programmable automation controller (PAC), instrumentation, motion control, and/or robotics.

Taken together, the control box (104) of the automated thermal spraying apparatus (101) generally serves two functions. The first is motive. The control box (104) provides the motion for moving the platform (107) up and down the vertical axis of the vertical support (102) via the motor (105). This movement can begin at the apex of the vertical support (102) and systematically progress downward toward the base (103) of the vertical support (102) or it can begin at the base (103) of the vertical support (102) and systematically progress upward toward the apex. The vertical movement can be one length of the vertical support (102) or can be multiple lengths of the vertical support (102), depending upon the desired properties of the end product thermal spray coating on the substrate. Further, it should be noted that it is not necessary for the motor (105) of the control box (104) to move the platform (107) along the entire length of the vertical support (102). While it is contemplated in some embodiments that the platform (107) will be moved from the base (103) of the vertical support (102) to the apex of the vertical support (102), this range of movement is not necessary. Any length or movement by the platform (107) along the vertical axis of the vertical support (102) is contemplated.

The second function served by the control box (104) of the automated thermal spray apparatus (101) (in the embodiments of the control box that have an automotive means) is the automation of the thermal spray process. The automotive means (106) of the control box (104) can regulate the rate and frequency of the movement of the platform (107) along the vertical support (102). In other embodiments, it is also contemplated that the control box (104) of the automated thermal spray apparatus (101) can be programmed to also regulate the rate and frequency of the movement of the sliding mechanism (114) along the rail (108) and/or the rate of spray disbursed from the spray gun (109).

Another component part of the automotive thermal spray apparatus (101) is the platform (107). The platform (107) of the thermal spray apparatus (101) can be viewed in FIGS. 1 and 4. The platform (107) is oriented generally perpendicular to the vertical support (102) and is of a generally rigid construction. The platform (107) is attached to the control box (104) of the automated thermal spray apparatus (101). The platform (107) is the portion of the automated thermal spray device (101) that is manipulated up and down the vertical axis of the vertical support (102) from the apex of the vertical support (102) to the base (103) of the vertical support (102) by the control box (104). Among other things, the platform (107) supports the rail (108), the secondary motor (110) (in some embodiments), the mechanical arm (111) and the sliding mechanism (114). The platform (107) is attached to the motor means (105) of the control box (104) by any means known to those of skill in the art for attaching a fixed flooring or horizontal surface to motorized structure such that the platform (107) will travel with the motorized structure as it moves along a fixed path, such as a vertical support (102). For example, in one embodiment, as depicted in FIG. 4, the platform (107) is rigidly attached to the motor means (105) of the control box (104) by bolts. Further, the platform (107) is attached or associated with the vertical support (102) by any way known to those of skill in the art for attachment that allows the platform (107) to travel the length of a fixed path defined by a vertical support (102).

Any shape or size platform (107) that is capable of being manipulated up and down the vertical support (102) by the control box (104) and is capable of supporting at least the rail (108) and the sliding mechanism (114) is contemplated in this application. Further, it is contemplated that the platform (107) may be comprised of any material or composition that can accomplish these functions. For example, in one embodiment, the platform (107) is comprised of metal.

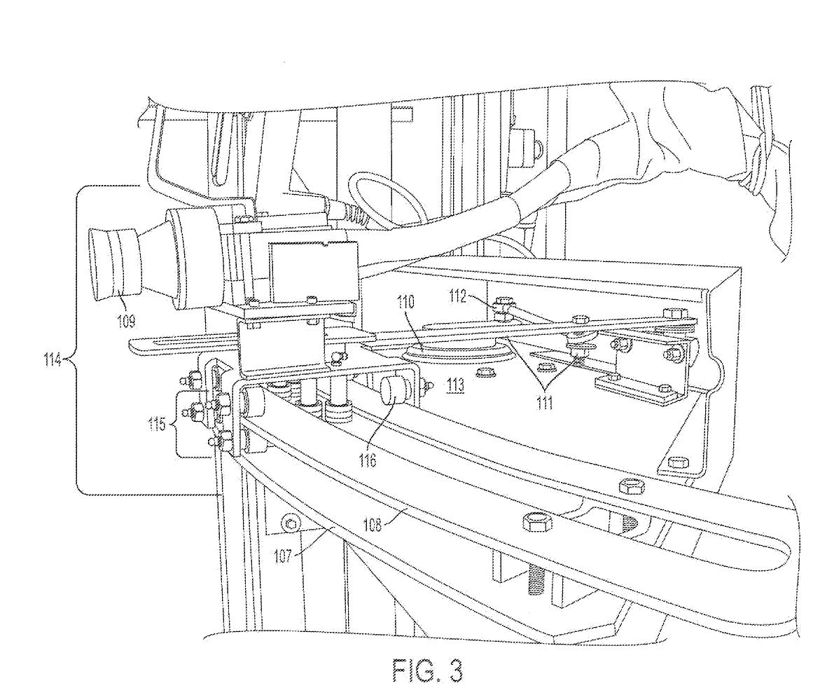

Yet another component part of the automated thermal spray apparatus (101) is the secondary motor (110). The secondary motor (110) can be seen in FIGS. 1-3. In one embodiment, the secondary motor (110) is attached to the platform (107). However this specific attachment is in no way determinative. Akin the means (105) for imparting vertical motion to the platform (107) located in the control box (104) of the automated thermal spray device (101), it is contemplated that the secondary motor (110) may consist of any type of motor or other means for imparting mechanical energy and motion to an object to move the object. It is contemplated that the secondary motor (110) may be attached to any portion of the thermal spray apparatus (101) that allows the secondary motor (110) to interact with the mechanical arm (111) such that the secondary motor (110) can impart motion to the mechanical arm (111) and the mechanical arm (111) can then impart motion to the sliding mechanism (114) to move it along the fixed path defined by the rail (108). For example, in one embodiment of the automated thermal spray apparatus (101), the secondary motor (110) is imbedded in the platform (107) such that a top portion of the secondary motor (110) is flush with or above the platform (107) and the rest of the secondary motor (110) is located in or below the platform (107). A depiction of this orientation of the secondary motor (110) can be seen in FIG. 3. In other embodiments, it is contemplated that the secondary motor (110) is attached to the control box (104) or at some other location on the platform (107).

The secondary motor (110) imparts mechanical motion onto the mechanical arm (111). It is contemplated that this may be accomplished my any method known to those of skill in the art for imparting mechanical motion onto a mechanical arm (111) such that the mechanical arm (111) is able to move an object, such as a sliding mechanism (114), along a fixed rail. One example of such secondary motor used is a swing motor. In one embodiment of the present automated thermal spraying apparatus (101), as depicted in FIG. 3, this motion is imparted by a circular mechanical force. In the embodiment of the secondary motor (110) where the motion imparted to the mechanical arm (111) is by circular mechanical force, the movement of the secondary motor (110) in the circular pattern transfers movement to the mechanical arm (111) that is attached to the top of the secondary motor (110). This circular pattern can be 360 degrees, 180 degrees, 90 degrees, 60 degrees or any circular path sufficient to manipulate the mechanical arm (111) such that the mechanical arm (111) is able to impart motive force to the sliding mechanism (114) to move it along the path defined by the rail (108). The interaction of the secondary motor (110) with the mechanical arm (111) and the sliding mechanism (114) will be more fully discussed later in this application.

In some embodiments of the automated thermal spray apparatus (101), the secondary motor (110) also contains a system or means for automating the movement of the secondary motor and, by extension, the rate at which the sliding mechanism moves along the rail (108). Any means for automating a motor to impart mechanical motion onto a mechanical arm (111) such that the mechanical arm (111) is able to move an object, such as a sliding mechanism (114), along a fixed rail is contemplated. These include, but are not limited to, CAx, PLC, ANN, DCS, HMI, PAC, instrumentation, motion control, robotics and/or simply an on/off switch.

Another component part of the automated thermal spray apparatus (101) is the mechanical arm (111). Generally, the mechanical arm (111) is any mechanical arm known to those of skill in the art for imparting motion from a motor, such as the secondary motor (110), to a sliding mechanism such that the sliding mechanism can be manipulated along a fixed and defined path, such as a rail, by the mechanical arm (111). One portion of the mechanical arm (111) is attached to the secondary motor (110). Any attachment means known to those of skill in the art is contemplated for this attachment. Further, another portion of the mechanical arm (111) is attached to the sliding mechanism (114). Again, any attachment means known to those of skill in the art is contemplated for this attachment.

In one embodiment, the mechanical arm (111) has a proximal end and a distal end and a length therebetween. In this embodiment, the attachment of the mechanical arm (111) to both the secondary motor (110) and the sliding mechanism (114) can be at the proximal or terminal end of the mechanical arm (111) or anywhere along the length therebetween. Further, it should be recognized that the mechanical arm (111) can be a single arm component, or can be comprised of multiple component arms attached together to create a unitary mechanical arm (111).

In one embodiment of the multi-component mechanical arm (111), the mechanical arm (111) is generally comprised of two component parts. This embodiment of the mechanical arm is depicted in FIG. 3. The first component part of the mechanical arm (111) in this embodiment is the secondary flange (112). The secondary flange (112) has a proximal end and a distal end and a length therebetween. The secondary flange (112) of the mechanical arm (111) is attached to the secondary motor (110) generally at its distal terminal end. This attachment can be accomplished by a bolt, as depicted in the FIG. 3, or by any other modality known to those of skill in the art for attachment. The proximal end of the secondary flange (112) is attached to a spot along the length of the main arm (113). This attachment can be accomplished by a bolt, as depicted in FIG. 3, or by another mechanism known to those of skill in the art for attachment. In this embodiment of the multi-component mechanical arm, the secondary flange (112) functions to impart motion from the secondary motor (110) to the main arm (113).

The second component part of this embodiment of the multi-component mechanical arm (111) is the main arm (113). The main arm (113) is generally comprised of a proximal end and a distal end and a length therebetween. The distal end of the main arm (113) is attached to the platform (107) by a rotating pivot point. This type of attachment allows the main arm (113) to be manipulated by the secondary flange (112) along the path defined by the rail (108) as the secondary flange (112) is moved by the secondary motor (110) to which it is attached. In embodiments where the rail (108) covers a curved path, a proper analogy for this movement would be the closing and opening of a door, where the door is the main body (113) of the mechanical arm (111), the attachment of the door to the wall is the rotating pivot point and the opening and closing of the door (imparting movement to the door) is the secondary flange (112). Stated differently, the movement of the mechanical arm (111) is such that the distal end is always attached to a fixed rotating or hinging point on the platform (107) and the main body (113) of the mechanical arm (111) is manipulated from this fixed point by the secondary flange (112).

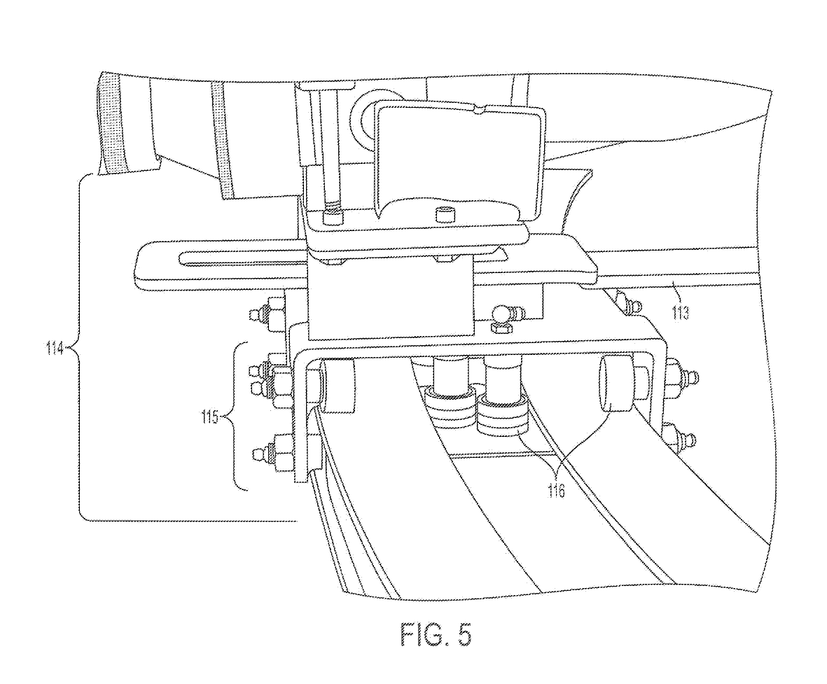

Yet another component part of the automated thermal spray apparatus (101) is the sliding mechanism (114). Different perspective views of the spray sliding mechanism (114) can be seen in FIGS. 1-3. A close-up view of the sliding mechanism (114) can be seen in FIG. 5. The sliding mechanism (114) is attached at a position along the mechanical arm (111) such that the mechanical arm (111) can impart motion onto the sliding mechanism (114) to move it along the rail (108). In the specific embodiment of the multi-component mechanical arm (111) discussed above, the sliding mechanism (114) is attached at a position generally located at the proximal end of the main arm (113). The sliding mechanism (114) is attached to the mechanical arm (111) by any form of attachment, be it rigid or moveable, known to those of skill in the art that allows for the sliding mechanism (114) to move along with and in the same plane of movement as the mechanical arm (113) and to follow the fixed path defined by the rail (108).

The sliding mechanism (114) is generally comprised of a slide (115). As depicted in FIGS. 3 and 5, the slide (115) is a sliding sleeve that is moveably attached to the rail (108) such that it slides along the length of the fixed path of the rail (108) as movement is imparted to it from the mechanical arm (111). It should be recognized that any form of moveable attachment known to those of skill in the art that would allow the sliding mechanism (114) to move along the fixed path defined by the rail (108) is contemplated as a form of attachment of the sliding mechanism (114) to the rail (108). In one embodiment of the sliding mechanism (114), this sliding movement is accomplished by slider rollers (116) which are attached to the slide (115). In one embodiment, the slider rollers (116) are attached in a horizontal orientation positioned directly above and below the rail (108), on generally the same vertical plane, hugging the rail (108). In some embodiments of the sliding mechanism (114), slider rollers (116) are also attached to the slide (115) in a vertical orientation, perpendicular to the horizontally oriented rollers (116). These vertically oriented slider rollers (116) occupy the internal space between the tracks of the rail (108) in the embodiments of the rail (108) where there are two or more tracks, such that they roll along the internal edges of the two tracks of the rail (108). In embodiments of the automated thermal spray apparatus (101) where the rail (108) consists of one track instead of two or more parallel tracks, the sliding mechanism (114) will usually have horizontally positioned slider rollers (116); it will generally not have vertically arranged slider rollers (116).

Generally, it is contemplated that the thermal spray gun (109) is attached to the sliding mechanism (114). The spray gun (109) is a thermal spray gun of any type known to those in the art of thermal spraying. It is contemplated that the spray gun (109) can be temporarily or permanently attached to the sliding mechanism (114). In one embodiment, as depicted in the FIGS., the spray gun (109) is attached to the top of the slide (115) such that the nozzle moves with the slide (115) as the slide (115) is propelled along the horizontal rail (108) by the mechanical arm (111). Generally, the spray gun (109) will be oriented such that the nozzle of the spray gun (109) from which the thermal spray is dissipated is directed towards the substrate to be sprayed. It is contemplated that the spray gun (109) will have all of the attachments that are traditional to have attached to a spray gun (109) and are known to those of skill in the art to be necessary for the proper functioning and operation of a thermal spray gun. These include, but are not limited to, the feeder supply (the attachment that delivers the feedstock), the media supply (the attachment that delivers the gas or other media used to heat the feedstock) and the power supply.

Another component part of the automated spraying apparatus (101) is the rail (108). Different views of an embodiment of the rail (108) can be seen in FIGS. 1-3 and 5. Generally, the shape of the rail (108) mirrors or corresponds to the shape of the surface area of the substrate that is being sprayed. Thus, for example, if the surface area of the substrate is flat, the rail (108) will be a linear path. If the surface area of the substrate is curved, then the rail (108) will be a mirrored curve path. This particular curved embodiment of the rail (108) is depicted in the FIGS. If the area of the substrate is an irregular polygonal-type shape, then the horizontal rail (108) could be a mirror image of the irregular polygonal-shape of the substrate or may be a smooth curve approximating the general shape or arch of the substrate surface area. For the purposes of this disclosure, the rail (108) shown in FIGS. 1-3 and 5 is a curved rail.

The rail (108) is rigidly attached to the platform (107) and moves in concert with the platform (107) as the platform (107) is manipulated along the length of the vertical support (102). In the embodiments of the rail (108) where the rail (108) is generally a curved rail, the curved rail (108) will often be oriented with the peak of the curve located at the central position between the two terminating ends of the rail (108) however, other orientations are possible. This curved orientation of the horizontal rail (108) can be most clearly seen in FIGS. 1, 3 and 5. As depicted in FIG. 3, when the sliding mechanism (114) is located at the apex or peak of the curve of the rail (108) the main arm (113) (in the embodiment of the multi-component mechanical arm (111)) will generally be in a plane parallel to the horizontal orientation of the vertical support (102).

In different embodiments, the rail (108) can comprise a single track or two or more separate tracks with a space therebetween. In both the single track and multi-track embodiments of the rail (108), the rail (108) is raised above the platform (107) to the extent necessary for the slide (105) of the sliding mechanism (114) to be able to move along the length of the rail (108) without encountering too much friction or resistance. In the embodiment of the sliding mechanism (114) where the slide (115) of the sliding mechanism (114) moves by slider rollers (116), the rail (108) is raised above the platform (107) to the extent necessary such that the horizontally oriented slider rollers (116) can be positioned between the underside of the rail (108) and the platform (107) in such a way as to minimize frictional resistance to the slider rollers (116). Further, in both the single track and multi-track embodiments of the rail (108), the thickness of the horizontal rail (108) can be any thickness known to those of skill in the art such that the horizontally positioned slider rollers (116) of the slide (115) can be positioned directly above and below the rail (108) hugging the rail (108) on the same vertical plane such that the slide (115) can move freely and easily along the length of the rail (108).

One embodiment of a multi-track rail (108) can be seen in FIGS. 1-3 and 5. This embodiment of the multi-track rail (108) depicted in the FIGS. consists of two separate tracks and a space therebetween. As seen most clearly in FIG. 5, in the depicted embodiment of the multi-track rail (108) the two separate tracks of the rail (108) are generally of an equal width. However, one of ordinary skill in the art would recognize that the width of the individual tracks of any multi-track rail (108) can vary and do not necessarily have to be equal in width. In fact, any track(s) which allow the sliding mechanism (114) to slide along the length of the rail (108) are contemplated in this application.

In general, the automated thermal spray apparatus (101) has two main components of motion that work in tandem to apply a thermal spray coating to a substrate: a vertical component and a horizontal component. The vertical support (102), the control box (103) and the platform (107) work together to create the vertical component of motion of the automated thermal spray apparatus (101). As briefly described previously in this disclosure, in the vertical component of motion, the motor means or system (105) for imparting vertical motion to the platform (107) of the automated spraying apparatus (101) moves the platform (107) of the automated spraying apparatus (101) up and down a length of the vertical axis of the vertical support (102), in some embodiments from the apex to the base (103) or the base (103) to the apex of the vertical support (102). In some embodiments, the platform (107) will not move up or down (whichever the progression of vertical movement) to the next point on the vertical axis until the sliding mechanism (114) has finished a complete cycle on the rail (108).

A complete cycle, as that term is used herein, means a complete defined range of movement along the rail (108). This could be a movement from one terminating end of the rail (108) to the opposite terminating end of the rail (108) and then back again to the original, starting terminating end of the rail (108). It could also simply mean one terminating end of the rail (108) to the other terminating end of the rail (108). Generally, any fixed and defined path along the rail (108) that is repeated in the same manner as the platform (107) travels up and down the vertical rail (102) is contemplated as a complete cycle on the rail (108).

Once the sliding mechanism (114) has finished a complete cycle on the rail (108), the motor means (105) for imparting vertical motion to the platform (107) of the automated thermal spray apparatus (101) will move the platform (107) to the next vertical step on the vertical axis of the vertical support (102) (whether that be up or down the vertical support (102)) where the sliding mechanism (114) will complete another cycle on the rail (108) before the platform (107) is moved to its next spot along the vertical support (102).

In other embodiments, the motor means (105) will move the platform (107) at a constant rate of climb, regardless of whether a complete cycle of horizontal movement has been completed. In these embodiments, the motor means (105) causes the platform (107) to climb up or down the vertical support (102) a relatively small amount (for example, about one to five inches) per single cycle of the sliding mechanism (114) on the horizontal rail (108). This will result in a spray being applied at an angle relative to the plane of the deposition surface.

The horizontal component of motion is created by the interaction of the secondary motor (110), the mechanical arm (111), the sliding mechanism (114) and the rail (108). In the embodiment of the mechanical arm where the mechanical arm (111) is a single unitary component, the horizontal component of motion for the apparatus (101) occurs as follows. As noted previously in this application, in the embodiment of the mechanical arm (111) where the mechanical arm (111) is simply comprised of a terminal end, a distal end and a length therebetween, one point along the length of the arm (111) will be attached to the secondary motor (110). By this attachment, the motive force of the secondary motor is imparted to the mechanical arm (111). The mechanical arm (111) is also attached to the sliding mechanism (114) at one point along its length. The movement imparted to the mechanical arm (111) by the secondary motor (110) is imparted to the sliding mechanism (114) via this attachment. This motive force moves the sliding mechanism (114) along a length of the fixed and rigid path defined by the rail (108) which is attached to the platform (107).

In the particular multi-component mechanical arm (111) embodiment discussed previously in this application and displayed in the FIGs., the horizontal component of motion for the apparatus (101) occurs as follows. In this embodiment, the secondary flange (112) of the mechanical arm (111) is attached to the secondary motor (110). In one embodiment, the secondary flange (112) will be attached to the secondary motor (110) via its distal terminal end. In addition to being attached to the secondary motor (110), the secondary flange (112) is also attached to the main arm (113) at some point along its length. In one embodiment, the secondary flange (112) is attached to the main arm (113) at its proximal terminating end. By the attachment of the secondary flange (112) to the secondary motor (110), movement of the secondary motor (110) results in movement of the secondary flange (112). Further, via its attachment to the main arm (113), the secondary flange (112), imparts a mechanical force onto the main arm (113) of the mechanical arm (111), causing the main arm (113) to hinge back and forth in an arch from its rotational/hinged point of attachment to the platform (107). The sliding mechanism (114) is attached to both the proximal end of the main arm (113) and the rail (108) via the slide (115). Motion is imparted to the sliding mechanism (114) via its attachment to the proximal end of the main arm (113). Thus, the hinging of the main arm (113) (caused by a hinging of the main arm (113) from it rotational/hinged point of attachment to the platform (107)) causes the sliding mechanism (114) to slide along the rail (108).

While any portion of horizontal movement is contemplated, generally the movement will be from around one terminating end of the rail (108) to around the opposite terminating end of the rail (108). As described previously, a cycle of horizontal movement on the rail (108) is any repeated analogous movement on the rail (108). In one embodiment, the movement in one direction for a given distance can be one cycle and the movement in the reciprocal direction for the same given distance can be another cycle. In other embodiments, one cycle on the rail (108) can be a combination of the back and forth movement of the sliding mechanism (114) along the same distance of the rail (108). In one embodiment, a cycle is, at least, the movement of the sliding mechanism (114) from about one end of the rail (108) to the other end.

In some embodiments, the control box (104) of the automated thermal spray apparatus (101) automates the vertical component of motion of the thermal spray apparatus (101) and the secondary motor (101) automates the horizontal component of motion. Stated differently, the control box (104) of the automated thermal spray apparatus (101) regulates and controls the rate and frequency of the movement of the platform (107) along the vertical support (102) and the automotive means of the secondary motor (101) controls the rate and frequency of the movement of the sliding mechanism (114) along the rail (108). In some embodiments, the control box (104) will control both the vertical and horizontal components of motion. In addition to controlling the two components of motion, in some embodiments it is also contemplated that the control box (104) will also regulate the rate of spray dispersed from the spray gun (109). Stated differently, in these embodiments of the thermal spray apparatus (101), the control box (104) will regulate the speed at which the thermal spray is emitted from the spray gun (109). It is contemplated that this automation of the rate at which the thermal spray is emitted can also be automated by an automotive means in the secondary motor (110) in certain embodiments.

Taking the vertical and horizontal components of motion together, the automated thermal spray apparatus (101) of this application is a simple automated system for the consistent application of a thermal spray to a large area of a substrate. In this system, there is little backlash, and every point on the substrate is going to get much more clearly the same overlay of thermal spray than can occur with the manual application of a thermal spray to a substrate. While any number of cycles or passes along the rail (108) are contemplated, the total number of cycles or passes along the rail (108) for each new position of the platform (107) on the vertical axis (102) will generally be the same for each new position of the platform along the support (102). Thus, the entire surface area of the substrate generally receives a similar number of passes from the spray gun (109) and a generally equivalent coverage of thermal spray coating. Stated differently, each portion of the surface area of the substrate receives a similar number and rate of passes from a thermal spray gun (109) manipulated by the apparatus (101) such that, at the end of the spray process, the surface area of the substrate is covered with a coating of a generally uniform thickness and composition. In some embodiments, the automated thermal spray apparatus (101) is regulated such that there is a one third overlay of spray on the substrate from the previous cycle for each subsequent cycle of the sliding mechanism (114).

Thus, taken together, the combination of the vertical and horizontal components of motion of the apparatus (101) result in a certain defined and equal spray pattern on the substrate. In the embodiment in which the platform (107) moves up and down the vertical support at a constant rate, regardless of whether a cycle has been completed, the pattern of the spray on the substrate will be a general zigzag or flat helix pattern with equal overlapping of the spray in each zigzag, resulting in a coating of generally the same width and coverage across the whole surface area of the substrate after a certain number if passes have been performed. In other embodiments, there is no overlap or gaps between each horizontal cycle or pass for each separate position of the platform (107) on the vertical axis.

The advantages of the presently disclosed automated thermal spraying apparatus (101) over the prior art are three-fold. First, the automated process of the automated thermal spraying apparatus (101) disclosed herein can remove the “human error” factor present in any manual application of a thermal spray. The automated process is simply better equipped to hold constant the varying parameters and variables involved in thermal spraying than manual application. Second, automated thermal spraying apparatus (101) disclosed herein is generally not as complex and expensive as the currently utilized hydraulic and robotic thermal spray applicators currently known in the art which are designed to provide a large freedom of motion. In contrast, the path of the device disclosed herein is generally relatively rigid and fixed. Thus, unlike these apparatuses, it does not add needless complexity and expense to the manufacturing process. Third, the automated thermal spray apparatus (101) disclosed is readily adaptable to a number of differently shaped substrates. By manipulating the shape of the rail (108) to correspond with the surface area of the substrate, every point of the surface area of the substrate will be covered with the same exact portion of a thermal spray coating, no matter its shape.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. An automated thermal spray apparatus, said automated thermal spray apparatus comprising:
a vertical support;
a platform attached to said vertical support;
a control box, said control box including a motor for moving said platform of said automated thermal spray apparatus up and down said vertical support;
a secondary motor;
a mechanical arm attached to said platform and to said secondary motor;
a rail attached to said platform;
a sliding mechanism attached to said mechanical arm and moveably attached to said rail;
wherein said motor of said control box moves said platform up and down said vertical support to create a vertical component of motion;
wherein said secondary motor imparts motion on said mechanical arm and said mechanical arm imparts motion on said sliding mechanism to move said sliding mechanism along said rail to create a horizontal component of motion.

2. The automated thermal spray apparatus of claim 1, wherein the vertical support is comprised of a single bar.

3. The automated thermal spray apparatus of claim 1, wherein the vertical support is a mirror image of a substrate being sprayed by said automated thermal spray apparatus.

4. The automated thermal spray apparatus of claim 1, wherein the vertical support is comprised of one or more bars located in the same vertical plane.

5. The automated thermal spray apparatus of claim 1, wherein the end of the vertical support oriented towards the ground is attached to a base.

6. The automated thermal spray apparatus of claim 5, wherein the base is motive.

7. The automated thermal spray apparatus of claim 1, wherein the motor for moving the platform up and down the vertical support of the automated thermal spray apparatus is a stepper motor.

8. The automated thermal spray apparatus of claim 1, wherein the control box further comprises a processor for automating the vertical component of movement of the platform.

9. The automated thermal spray apparatus of claim 8, wherein the processor for automating the vertical component of movement of the platform is selected from the group consisting of: computer-aided technologies, programmable logic controllers, artificial neural networks, distributed control system, human machine interface, programmable automation controllers, instrumentation, motion control, robotics and an on/off switch.

10. The automated thermal spray apparatus of claim 8, wherein said control box regulates the rate and frequency of said horizontal component of motion.

11. The automated thermal spray apparatus of claim 8, wherein said control box regulates the rate of said spray disbursed from said spray gun.

12. The automated thermal spray apparatus of claim 1, wherein the mechanical arm comprises:
a secondary flange having a distal and a proximal end and a length therebetween;
a main arm having a distal and a proximal end and a length therebetween;
wherein the distal end of said secondary flange is attached to said secondary motor;
wherein the proximal end of said secondary flange is attached to said main arm at said length therebetween said distal and said proximal ends of said main arm;
wherein said distal terminal end of said mechanical arm is rotably attached to said platform;
wherein said secondary motor imparts motion to said secondary flange, said secondary flange imparts motion to said main arm and said main arm imparts motion to said sliding mechanism to move said sliding mechanism along a length of said rail to create a horizontal component of motion.

13. The automated thermal spray apparatus of claim 1, wherein the sliding mechanism is moveably attached to said rail by slider rollers.

14. The automated thermal spray apparatus of claim 1, where a thermal spray gun is attached to said sliding mechanism.

15. The automated thermal spray apparatus of claim 1, wherein the rail is a linear rail.

16. The automated thermal spray apparatus of claim 1, wherein the rail is a curved rail.

17. The automated thermal spray apparatus of claim 1, wherein the rail is comprised of a single track.

18. The automated thermal spray apparatus of claim 1, wherein the rail is comprised of one or more tracks with a space therebetween.

19. The automated thermal spray apparatus of claim 1, wherein said vertical component of motion and said horizontal component of motion work in tandem to create a final thermal spray covering of uniform thickness on a surface area of a substrate of a uniform composition.

20. The automated thermal spray apparatus of claim 1, wherein the automated thermal spray apparatus is regulated to create a one-third overlay of thermal spray on a substrate from one horizontal pass of said sliding mechanism to a subsequent pass of said sliding mechanism.
